(19) United States
(12) Patent Application Publication
(10) Pub. No.: US 2008/0250632 A1
(43) Pub. Date: Oct. 16, 2008

(54) SYSTEM AND METHOD OF A CONFORMABLE CABLE

(76) Inventors: Douglas C. Dayton, Harvard, MA (US); Sung Park, Newton, MA (US); Samuel L. Palmer, Arlington, MA (US); Elizabeth Johansen, Somerville, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/029,550

(22) Filed: Feb. 12, 2008

Related U.S. Application Data
(60) Provisional application No. 60/901,296, filed on Feb. 12, 2007.
(60) Provisional application No. 60/901,238, filed on Feb. 12, 2007.

(51) Int. Cl. H01R 43/00

(52) U.S. Cl. 29/825; 29/850; 174/84 R

(57) ABSTRACT

A method and system for providing a conformable cable are described. The method and system may include disposing a conformable material along at least a portion of a cable and configuring the cable into a desired position and shape in which the shape of the cord remains unchanged.

### CROSS-REFERENCE TO RELATED APPLICATIONS

This application claims the benefit of the following provisional applications, each of which is hereby incorporated by reference in its entirety: U.S. Provisional Application No. 60/901,296 filed Feb. 12, 2007 and U.S. Provisional Application No. 60/901,238 filed Feb. 12, 2007.

### FIELD OF INVENTION

The invention herein disclosed generally refers to cables, and specifically to conformable cables.

### BACKGROUND

Power cords and connector cables are used to connect an appliance with power outlets. These power outlets may lie behind heavy furniture, televisions and couches in furnished rooms and offices. In addition, these power outlets may be located at a very low height or in areas having limited accessibility. The power cords and connector cables are flexible which allows them to reach the limited accessible areas.

The flexibility of power cords and connector cables causes them to become easily tangled and wrapped around themselves and other cords and objects. Also, these power cords and connector cables do not possess sufficient internal structural integrity to resist the pull of gravity under their own weight and fall down to the ground. In addition, these types of flexible power cords and connector cables fall back behind desks and furniture if not secured or attached.

Therefore, there exists a need for a power cord or a connector cable so that the disadvantages associated with power cords or a connector cable can be overcome.

### SUMMARY

The present invention provides a method and system of a conformable cable. The method and system may include disposing a conformable material along at least a portion of a cable and configuring the cable into a desired position and shape in which the shape of the cable remains unchanged.

In embodiments, the entire length of cable may be conformable. In embodiments, only a portion of the cable may be conformable. In embodiments, the portion may comprise a terminal portion. In embodiments, the portion may comprise a central portion. In embodiments, the conformable material may comprise a wire molded into the cable to confer conformability.

In embodiments, the conformable material may comprise a highly ductile metal molded into the cable to confer conformability. In embodiments, the conformable material may comprise a highly ductile metal over-molded onto the cable to confer conformability. In embodiments, the conformable material may comprise a wire over-molded onto the cable to confer conformability. In embodiments, the conformable material may comprise a conformable sheath surrounding some or all of the conductors within the cable.

In embodiments, the conformable material may comprise a spiral stiffening member disposed along a portion of the cable. In embodiments, the spiral stiffening member may be disposed adjacent to an insulating wrap, wherein the insulating wrap provides separation between the signal wires of the cable and the stiffening member. In embodiments, the fabrication of the spiral stiffening member may comprise winding or weaving in a pattern along the cable to facilitate supporting the cable to hold its shape. In embodiments, a protective and/or insulating sheath may be disposed on the spiral stiffening member. In embodiments, the sheath may provide one of a decorative or design benefit.

In embodiments, the wire may be disposed within the signal carry wires of the cable. In embodiments, the insulating wrap may be disposed on the wire to provide separation from the signal carry wires. In embodiments, the metal may be disposed within the signal carry wires of the cable. In embodiments, the insulating wrap may be disposed on the metal to provide separation from the signal carry wires.

In embodiments, over-molding may comprise a non-conductive material capturing the metal on the outer surface of the cable.

In embodiments, the cable may comprise one of a power cord and a data cord. In embodiments, the power cord may comprise one of a 110 VAC high current extension cords, an extension cord, an equipment cord, an appliance cord, and a power cord for a rechargeable device.

In embodiments, the data cord may comprise one of an optical cord, a fiber cord, a serial data cord, a parallel data cord, a Universal Serial Bus (“USB”) connector cord, a Firewire (IEEE 1394) connector cord, an audio connector cord, a digital player input connector cord, an RCA connector cord, a coaxial cable, a network cable, a D-shell monitor cable, a component audio cable, and a component video cable.

In an aspect of the invention, a system and method of a conformable extension cord may comprise disposing a conformable material along at least a portion of the extension cord, and configuring the extension cord into a desired position and shape in which the shape of the extension cord will remain unchanged. In the system and method, the extension cord may be a 110 VAC high current extension cord. In the system and method, the entire length or only a portion of the cable may be conformable.

In an aspect of the invention, a system and method of a conformable equipment cord may comprise disposing a conformable material along at least a portion of the equipment cord, and configuring the equipment cord into a desired position and shape in which the shape of the equipment cord will remain unchanged. In the system and method, the entire length or only a portion of the cord may be conformable.

In an aspect of the invention, a system and method of a conformable appliance cord may comprise disposing a conformable material along at least a portion of the appliance cord, and configuring the appliance cord into a desired position and shape in which the shape of the appliance cord will remain unchanged. In the system and method, the entire length or only a portion of the cord may be conformable.

In an aspect of the invention, a system and method of a conformable data cable may comprise disposing a conformable material along at least a portion of the data cable, and configuring the data cable into a desired position and shape in which the shape of the data cable will remain unchanged. In the system and method, the data cable may comprise at least one of an optical cord, a fiber cord, a serial data cord, a parallel data cord, a Universal Serial Bus (“USB”) connector cord, a Firewire (IEEE 1394) connector cord, an audio connector cord, a digital player input connector cord, an RCA connector cord, a coaxial cable, a network cable, a D-shell monitor cable, a component audio cable, and a component video cable.

In an aspect of the invention, a system and method may comprise providing a consumer-salable kit, wherein the consumer-salable kit may comprise a conformable material adapted to be attached to a separately sold cable, and an instruction guide instructing a user how to attach the conformable material to the cable and how to position the cable once the conformable material has been attached. In the system and method, the cable may comprise at least one of a power cord and a data cord. The power cord may comprise at least one of a 110 VAC high current extension cords, an extension cord, an equipment cord, an appliance cord, and a power cord for a rechargeable device. The data cord may comprise at least one of an optical cord, a fiber cord, a serial data cord, a parallel data cord, a Universal Serial Bus (“USB”) connector cord, a Firewire (IEEE 1394) connector cord, an audio connector cord, a digital player input connector cord, an RCA connector cord, a coaxial cable, a network cable, a D-shell monitor cable, a component audio cable, and a component video cable. In the system and method, positioning the cable may involve positioning and shaping the cable to at least one surface of an object. In the system and method, the entire length or only a portion of the cable may be conformable. The portion may comprise a central or a terminal portion. In the system and method, the conformable material may comprise a spiral stiffening member disposed along at least a portion of the cable. The spiral stiffening member may be disposed adjacent to an insulating wrap, wherein the insulating wrap provides separation between the signal wires of the cable and the stiffening member. The spiral stiffening member may include a protective and/or insulating sheath. The sheath may provide at least one of a decorative or design benefit. In the system and method, the conformable material may comprise at least one of a highly ductile metal, a wire, and a conformable sheath surrounding some or all of the conductors within the cable.

### BRIEF DESCRIPTION OF FIGURES

The features of the present invention, which are believed to be novel, are set forth with particularity in the appended claims. The invention may best be understood by reference to the following description, taken in conjunction with the accompanying drawings, wherein:

FIG. 1 illustrates an exemplary view of an electrical cord in accordance with an embodiment of the present invention;

FIG. 2 illustrates the use of the electrical cord that stays in position to provide a connector at table height in accordance with an embodiment of the present invention;

FIG. 3 illustrates the ability of a phone charger cord to maintain its position and shape to provide a connector above table height in accordance with an embodiment of the present invention;

FIG. 4 illustrates the construction of a power cable mated to a connector in accordance with an embodiment of the present invention;

FIG. 5 illustrates the use of a cable connector that substantially retain their shape and stay in position in accordance with an embodiment of the present invention;

FIG. 6 illustrates the construction of an exemplary conformable cable 602 for a D-shell monitor in accordance with an embodiment of the present invention;

FIG. 7 illustrates the construction of a conformable cable for a D-shell monitor in accordance with another embodiment of the present invention;

FIG. 8 illustrates the construction of a conformable cable for a USB connection in accordance with an embodiment of the present invention;

FIG. 9 illustrates the construction of a conformable cable for a USB connection in accordance with another embodiment of the present invention;

FIG. 10 illustrates the construction of a conformable cable for an RJ network connection in accordance with an embodiment of the present invention;

FIG. 11 illustrates the construction of a conformable cable for an RJ network connection in accordance with another embodiment of the present invention;

FIG. 12 illustrates the construction of a conformable cable for an RJ network connection in accordance with another embodiment of the present invention;

FIG. 13 illustrates a decorative extension cord in accordance with an embodiment of the present invention;

FIG. 14 illustrates a decorative extension cord in accordance with another embodiment of the present invention;

FIG. 15 illustrates a decorative extension cord in accordance with another embodiment of the present invention; and

FIG. 16 illustrates a conformable portion and a flexible portion in accordance with an embodiment of the present invention.

Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention.

### DETAILED DESCRIPTION

While the specification concludes with the claims defining the features of the invention that are regarded as novel, it is believed that the invention will be better understood from a consideration of the following description in conjunction with the drawings figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an”, as used herein, are defined as one or more than one. The term “another”, as used herein, is defined as at least a second or more. The terms “including” and/or “having” as used herein, are defined as comprising (i.e. open transition). The term “coupled” or “operatively coupled” as used herein, is defined as connected, although not necessarily directly, and not necessarily mechanically.

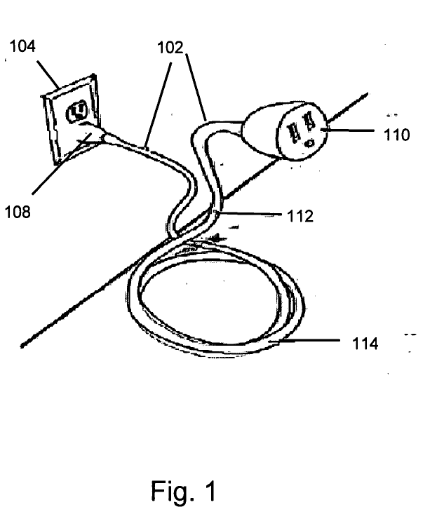

FIG. 1 illustrates a perspective view of an electrical cord 102 in accordance with an embodiment of the present invention. The electrical cord 102 may substantially retain its position and shape. The electrical cord 102 may be connected to a power outlet 104 which may have limited accessibility. For example, at one end, a male plug connector 108 of the electrical cord 102 may plug into a wall mounted power outlet 104. At the other end, a female plug connector 110 of the electrical cord 102 may be connected with an appliance. The female plug connector 110 of the electrical cord 102 may provide the power supply to the appliance from the power outlet 104. Examples of the appliance may include, but are not limited to a mobile, a laptop, a television set or some other type of device.

In embodiments, the electrical cord 102 may include a conformable portion 112 and a flexible portion 114. For example, a portion of the electrical cord 102 at the end of the female plug connector 110 may be conformable. This conformable portion 112 of the electrical cord 102 may substantially remain in a position in which a user places it. This conformable portion 112 may resist falling or drooping due to gravity or other relatively small forces. However, the conformable portion 112 may change its shape by an external force applied by the user. Once the conformable portion 112 changes its shape, then that shape may not be changed until another external force is applied. The conformable portion 112 of the electrical cord 102 may be provided by using a stiffening material. In embodiments, the electrical cord 102 cord may be stiffened partially with the stiffening material.

In addition, a portion of the electrical cord 102 at the end of the male plug connector 108 may be flexible. This flexible portion 114 of the electrical cord 102 may change its shape under the gravitational forces or relatively small forces. The length of the flexible portion 114 may depend upon the length of routing required for coiling. In embodiments, the flexible portion 114 may be coiled around a furniture, such as the leg of a table, chair.

The flexible portion 114 may provide a better ability to coil, fold, stow, or tuck the bulk of the electrical cord 102. Also, the electrical cord 102 may be less expensive if it does not require stiffening along its entire length. In embodiments, the overall weight of the electrical cord 102 may be less as the conformable portion 112 may not run along the entire length.

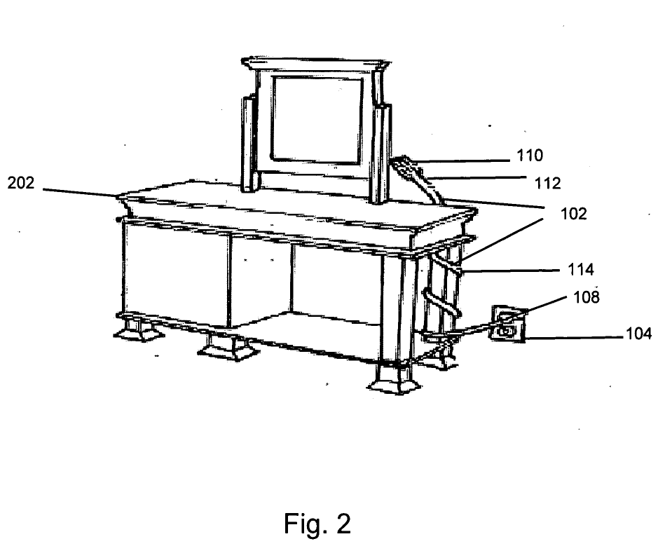

FIG. 2 illustrates the use of the electrical cord 102 that stays in position to provide a connector at various heights and positions in accordance with an embodiment of the present invention. To describe FIG. 2, reference will be made to FIG. 1, although it is understood that the electrical cord 102 that stays in position to provide a connector at various heights and positions may be practiced in the different embodiments.

As shown in FIG. 2, the electrical cord 102 may be used as a connector to provide power at a work surface 202. The work surface 202 may not be located at the height of the power outlet 104. The male plug connector 108 may plug into a power outlet 104 having limited accessibility. The electrical cord 102 may provide power at the work surface 202 through the female plug connector 110. The flexible portion 114 or the conformable portion 112 may be wrapped around the desk leg, or around some other part to provide temporary positioning to the electrical cord 102.

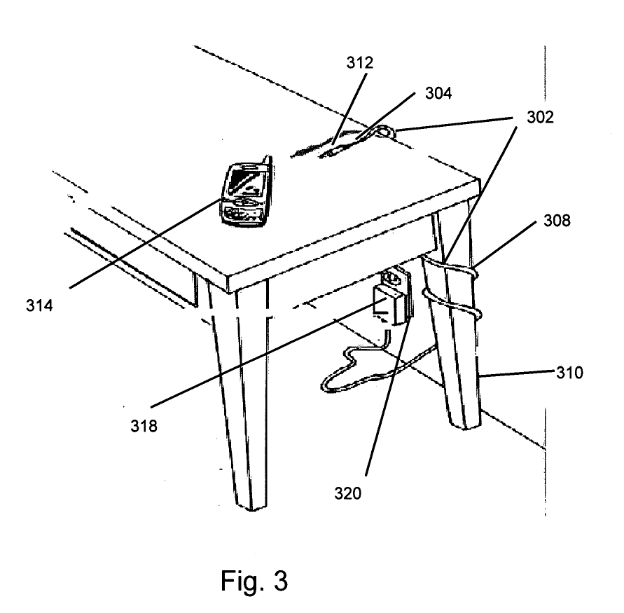

FIG. 3 illustrates the ability of a phone charger cord 302 to maintain its position and shape to provide a connector above table height in accordance with an embodiment of the present invention. To describe FIG. 3, reference will be made to FIG. 1 and FIG. 2, although it is understood that the phone charger cord 302 that stays in position to provide a connector at table height may be practiced in the different embodiments.

As shown in FIG. 3, a device charger cord 302 may have a conformable portion 304 and a flexible portion 308. As explained in the description of FIG. 1, the conformable portion 304 may retain its shape under the application of gravitational forces and the flexible portion 308 may be wrapped around any furniture and may change its shape under application of gravitational forces. The flexible portion 308 may be wrapped around a leg of the table 310. The conformable portion 304 may be provided near a charging pin 312 of the device charger cord 302. The device charger code 302 may also include a male plug connector 318 which may plug in to a limited accessible power outlet 320. The device 314 may be charged by taking power from the limited accessible power outlet 320 through the phone charger cord 302.

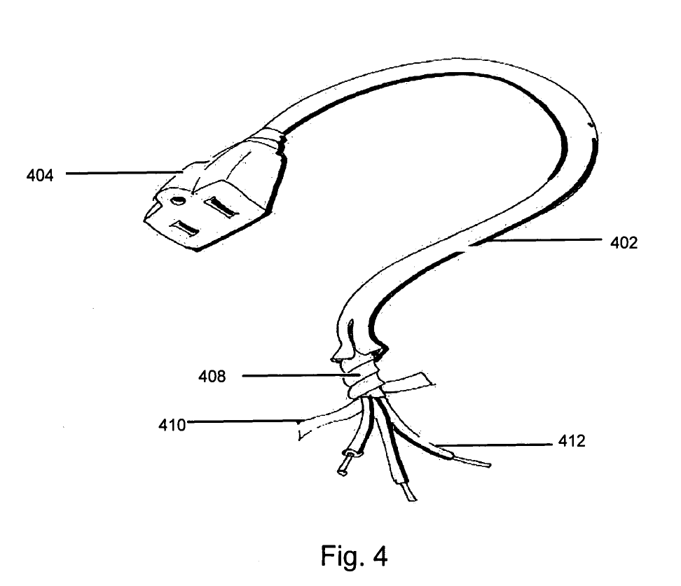

FIG. 4 illustrates an exemplary construction of cable 402 mated to a connector plug 404 in accordance with an embodiment of the present invention. The outer cover of the cable 402 may overlay a stiffened spiral member 408. The stiffening spiral member 408 may be enclosed within a protective and insulating sheath, which may also provide a decorative or design benefit. The stiffening spiral member 408 may be made up of various stiffening materials. In embodiments, the fabrication of the spiral stiffening member 408 may include winding or weaving in a pattern that may be helpful to supporting the cable 402 to hold its shape.

A spiral wound or woven insulating wrap 410 may provide separation from the power conductors. The power conductors may comprise hot, neutral and ground wires 412. In embodiments, the conformable segment may be constructed for the entire length of the cable 402. In embodiments, the conformable segment may be constructed for the partial length of the cable 402.

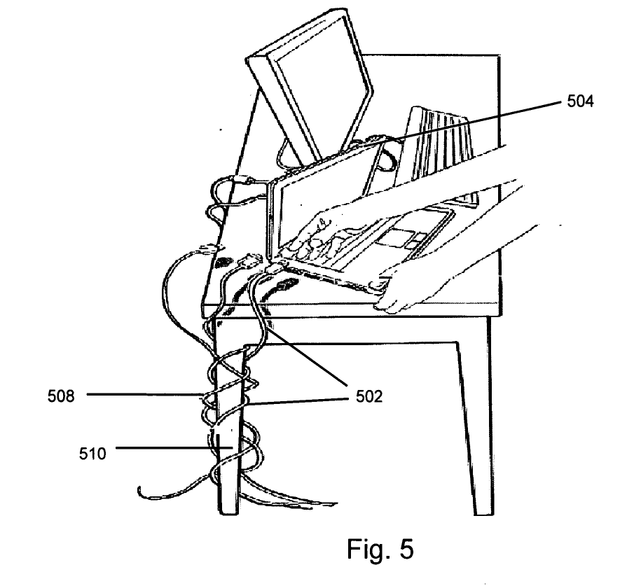

FIG. 5 illustrates the use of a cable connector 502 that substantially retains its shape and stays in position in accordance with an embodiment of the present invention. To describe FIG. 5, reference will be made to FIG. 1, although it is understood that the cable connector 502 may be practiced in the different embodiments. FIG. 5 shows a cable connector 502 that may be used to connect the inputs and outputs of a device 504, such as a portable laptop computer, to its various peripherals and to the network. A conformable portion 508 of the cable connector 502 may hold its shape when formed around the leg of a table 510 or any other object that is in the local environment. In embodiments, the conformable portion 508 may extend to the entire length of the cable connector 502. In embodiments, the conformable portion 508 may extend partially to the entire length of the cable connector 502.

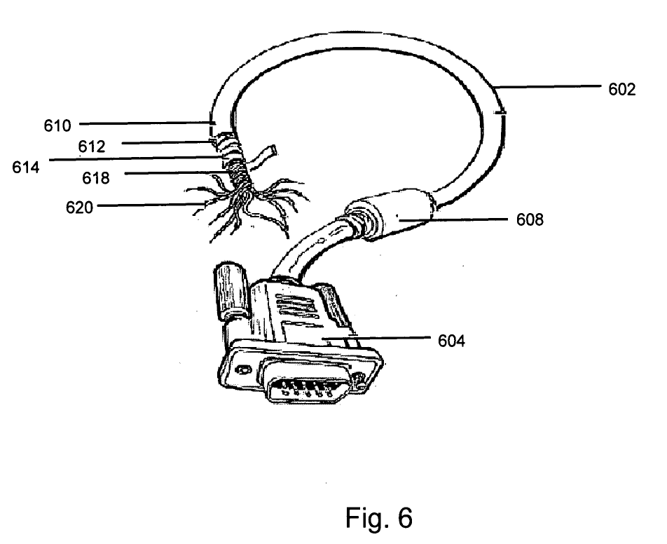

FIG. 6 illustrates the construction of an exemplary conformable cable 602 for a D-shell monitor in accordance with an embodiment of the present invention. The conformable cable 602 may be mated to a connector 604 of a parallel format communication protocol. The connector 604 may utilize the D-Shell standard geometry, such as RS-232 format, for cabling computers to monitors, printers and other peripherals. The conformable cable 602 may have an RF suppression device 608 integrated to its assembly. In embodiments, a conformable cable outer cover 610 of the cable 602 may overlay a spiral spring casing 612. The spiral spring casing 612 may include an insulating wrap 614. The insulating wrap 614 may separate a spiral wound bundle 618 of signal carrying wires 620 from the outer wrap of conformable material. In embodiments, the construction of the conformable segment may be for the entire length of the conformable cable 602. In embodiments, the conformable segment may be constructed for a partial length of the conformable cable 602.

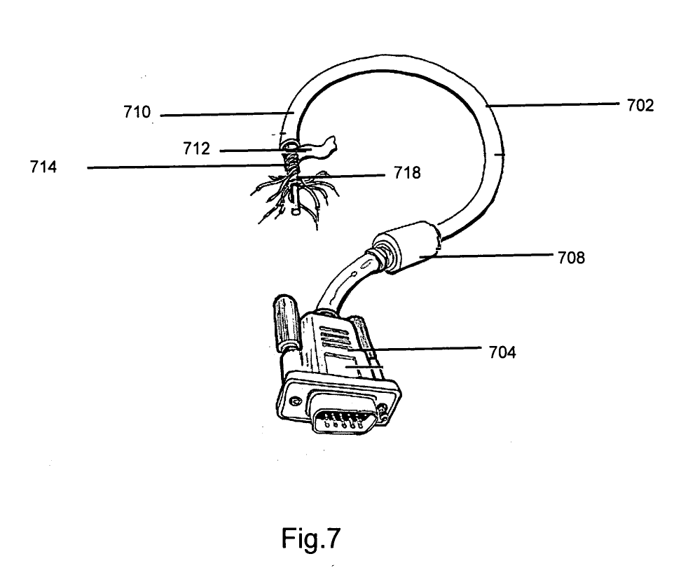

FIG. 7 illustrates the construction of a conformable cable 702 for a D-shell monitor in accordance with another embodiment of the present invention. The conformable cable 702 may be mated to a connector 704 of a parallel format communication protocol. The connector 704 may utilize the D-Shell standard geometry such as RS-232 format for cabling computers to monitors, printers and other peripherals. The conformable cable 702 may include an RF suppression device 708 integrated to its assembly. In embodiments, the outer cover 710 of the cable 702 may overlay a spiral wound insulating wrap 712. The spiral wound insulating wrap 712 may cover a spiral wound bundle 714 of signal carrying wire. The spiral wrapped bundle 714 of signal carry wires may include an insulating wrap 718 that may cover a highly ductile metal or other material wire. The highly ductile metal or some other material wire may provide conformability to the cable 702. In embodiments, the conformable segment may be constructed for the entire length of the conformable cable 702. In embodiments, the conformable segment may be constructed for the partial length of the conformable cable 702.

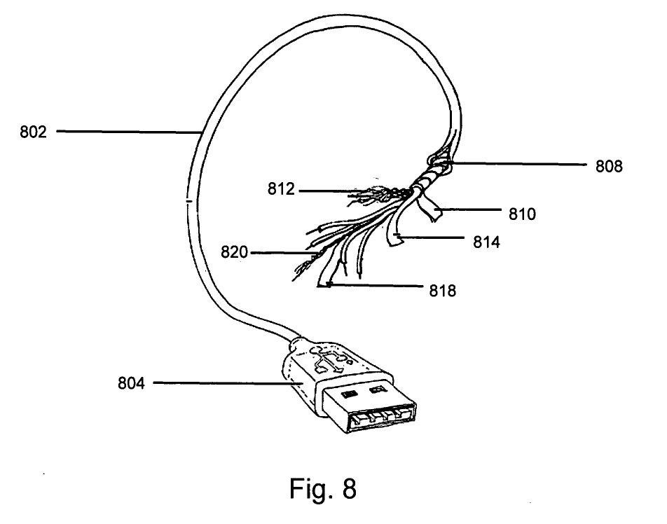

FIG. 8 illustrates the construction of a conformable cable 802 for a USB connection in accordance with an embodiment of the present invention. The conformable cable 802 may be mated with a connector 804. The connector 804, such as the Universal Serial Bus (“USB”) connector, may be used for cabling computers to printers and other peripherals. The outer cover of the conformable cable 802 may overlay a spiral spring casing 808. The spiral spring casing 808 may hold its shape after it is formed into a particular configuration. An insulating wrap 810, which is inside the spiral spring casing 808, may separate a coaxial braided ground jacket 812 from the signal carrying wires 814. The insulating wrap 810 may separate the coaxial braided ground jacket 812 from the inner wrap insulator 818 and the ground wire 820. In embodiments, the conformable segment may be constructed for the entire length of the conformable cable 802. In embodiments, the conformable segment may be constructed for the partial length of the conformable cable 802.

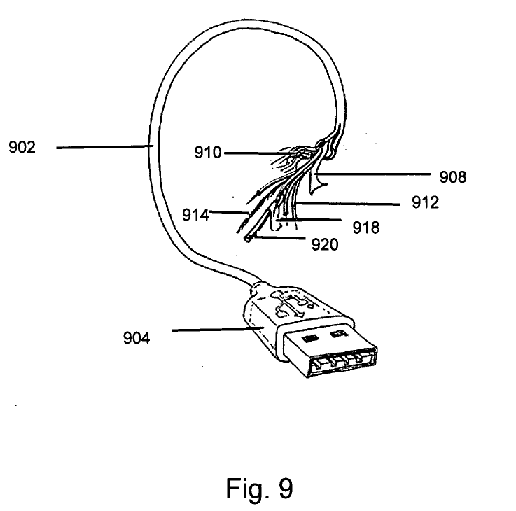

FIG. 9 illustrates the construction of a conformable cable 902 for a USB connection in accordance with another embodiment of the present invention. The conformable cable 902 may be mated with a connector 904. The connector 904, such as the Universal Serial Bus (“USB”) connector, may be used for cabling computers to printers and other peripherals. The outer cover of the conformable cable 902 may overlay a spiral wound insulating wrap 908 covering the coaxial braided ground jacket 910. The coaxial braided ground jacket 910 may surround the signal carrying wires 912 and the ground wire 914. An insulating wrap 918, which is inside of signal carrying wires 912, may cover a highly ductile metal or other material wire 920. The highly ductile metal or other material wire 920 may provide conformability to the conformable cable 902. In embodiments, the conformable segment may be constructed for the entire length of the conformable cable 902. In embodiments, the conformable segment may be constructed for the partial length of the conformable cable 902.

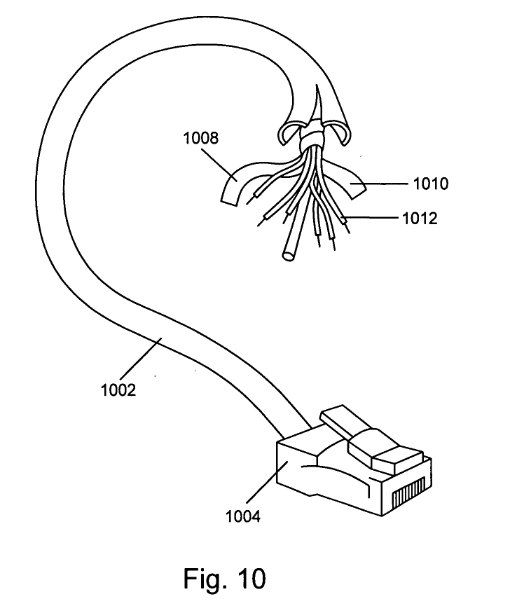

FIG. 10 illustrates the construction of a conformable cable 1002 for an RJ network connection in accordance with an embodiment of the present invention. The conformable cable 1002 may be mated with the common RJ connector 1004. The common RJ connector 1004 may be used for cabling computers to the elements of a local area network and to the Internet. The outer cover of the conformable cable 1002 may overlay a spiral spring casing 1008. An insulating wrap 1010, which is internal to the spring wrap, may provide separation from the signal carrying wires 1012. In embodiments, the conformable segment may be constructed for the entire length of the conformable cable 1002. In embodiments, the conformable segment may be constructed for the partial length of the conformable cable 1002.

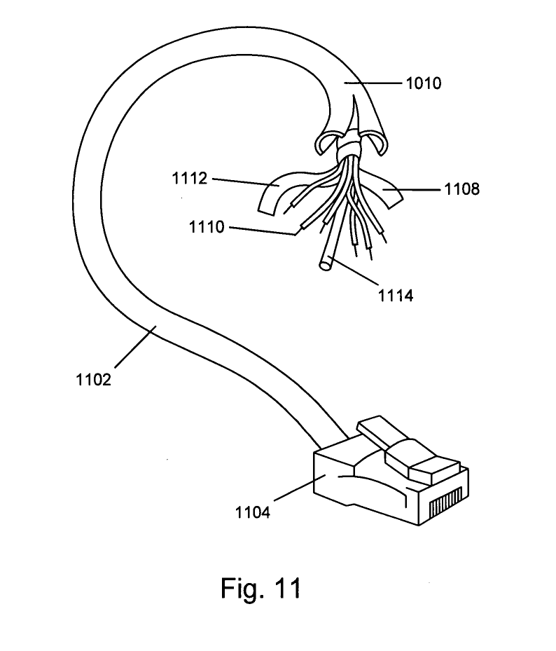

FIG. 11 illustrates a conformable cable 1102 for an RJ network connection in accordance with another embodiment of the present invention. The conformable cable 1102 may be mated with the common RJ connector 1104. The outer cover of the conformable cable 1102 may overlay a spiral wound insulating wrap 1108. The spiral wound insulating wrap 1108 may provide separation from the signal carrying wires 1110. The insulating wrap 1112, which is internal to the signal carrying wires 1110, may cover a highly ductile metal or other material wire 1114 which may provide conformability to the assembly. In embodiments, the conformable segment may be constructed for the entire length of the conformable cable 1102. In embodiments, the conformable segment may be constructed for the partial length of the conformable cable 1102.

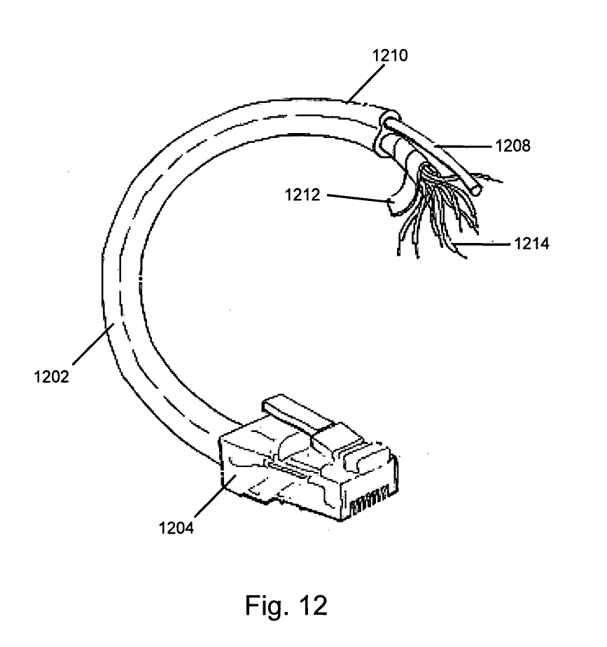

FIG. 12 illustrates a conformable cable 1202 for an RJ network connection in accordance with another embodiment of the present invention. The conformable cable 1202 may be mated with the common RJ connector 1204. The outer cover of the conformable cable 1202 may be over-molded with a compatible plastic material 1210 or other suitable over-molding material capturing a highly ductile metal or other material wire 1208 on the outer surface. The internal construction of the conformable cable 1202 may have an insulating wrap 1212. In embodiments, the internal construction of the conformable cable 1202 may vary with the communication standard employed. The insulating wrap 1212 may provide separation from the signal carrying wires 1214. In embodiments, the conformable segment may be constructed for the entire length of the conformable cable 1202. In embodiments, the conformable segment may be constructed for a partial length of the conformable cable 1202.

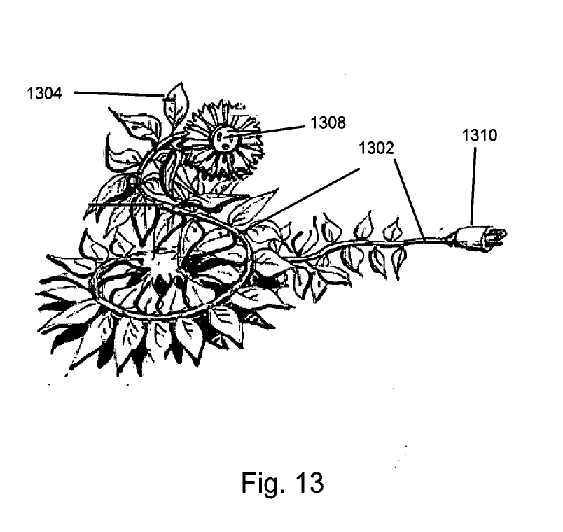

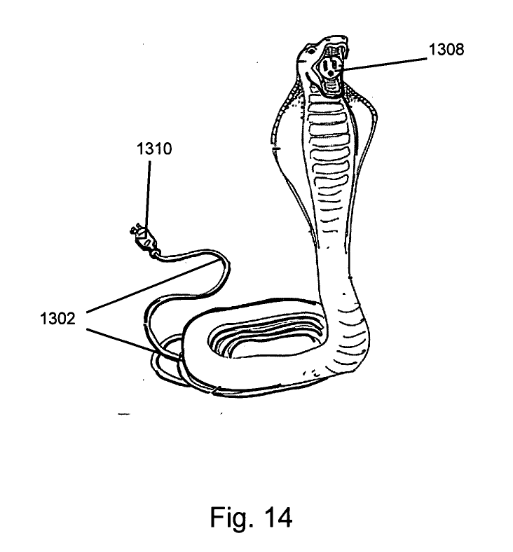

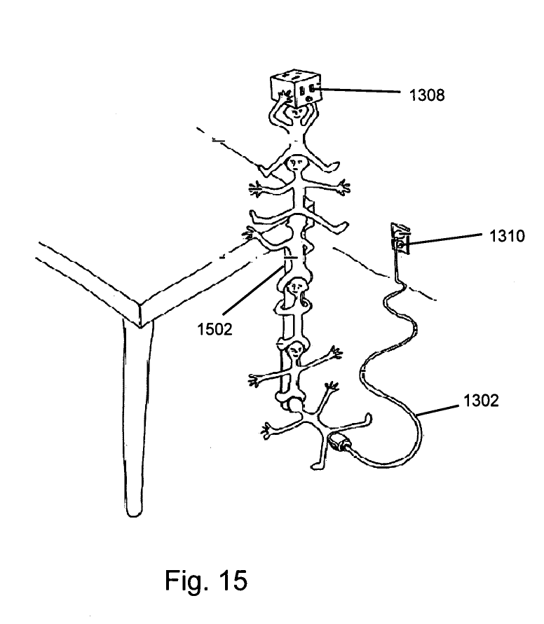

FIG. 13 illustrates a decorative extension cord 1302 in accordance with an embodiment of the present invention. The decorative extension cord 1302 may stay in position to provide a connector at various heights and/or positions and may be designed to be attractive, display a certain set of features and/or patterns, blend into or enhance an environment, and the like. For example, the decorative extension cord 1302 may look like a vine 1304 with flowers or other types of living plants. The visual aspects of the decorative extension cord 1302 may be manufactured by over-molding plastic or other materials onto a standard power cord. The visual aspects of the decorative extension cord 1302 may be made by incorporating the conductors into the plastic and/or other materials that are utilized by the faux plant and flower manufacturers to create a look that imitates a living plant. In the example, the decorative extension cord 1302 may utilize a standard female outlet 1308 configuration disguised within a flower 1310. In embodiments, as shown in FIG. 14, the decorative extension cord 1302 may utilize a standard female outlet 1308 configuration disguised in a snake's mouth. In embodiments, as shown in FIG. 15, the decorative extension cord 1302 may utilize a standard female outlet 1308 configuration disguised in a fictional pattern 1502.

The decorative extension cord 1302 may include a standard male power connection 1310. The standard male power connection 1310 may be plugged into a power outlet 1312. A length or a portion of the decorative extension cord 1302 may be conformable. The remaining length of the decorative extension cord 1302 may be flexible depending upon the overall length of the decorative extension cord 1302.

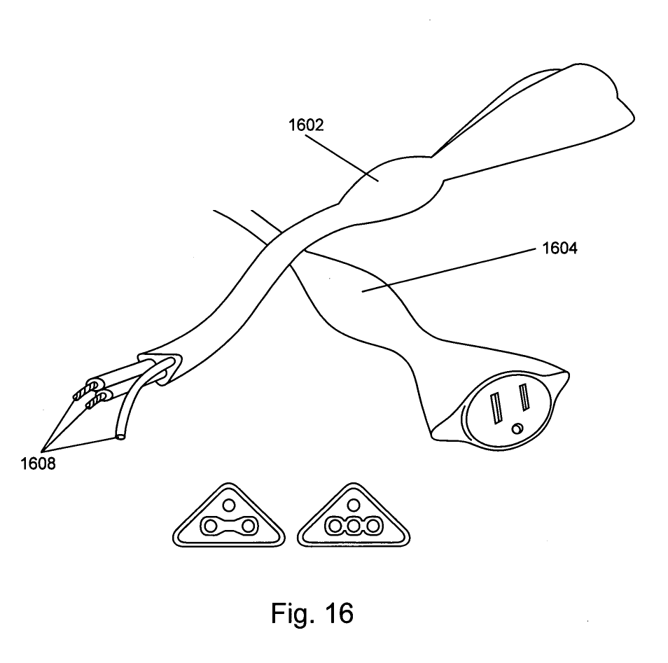

FIG. 16 illustrates an exemplary conformable portion 1602 and an exemplary flexible portion in accordance with an embodiment of the present invention. The conformable portion 1602, as explained in the description of FIG. 1, may resist falling or drooping due to gravity or other relatively small forces. However, the conformable portion 1602 may change its shape by an external force applied by the user. As shown, the conformable portion 1602 may have a bundle of signal carrying wires 1608. The flexible portion 1604 may change its shape under the gravitational forces or relatively small forces.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

1. A method of a conformable charging cable, comprising:
disposing a conformable material along at least a portion of the charging cable; and
configuring the charging cable into a desired position and shape in which the shape of the charging cable will remain unchanged.

2. The method of claim 1, wherein configuring the cable involves positioning and shaping the cable to at least one surface of an object.

3. The method of claim 1, wherein the entire length of cable is conformable.

4. The method of claim 1, wherein only a portion of the cable is conformable.

5-6. (canceled)

7. The method of claim 1, wherein the conformable material comprises a spiral stiffening member disposed along at least a portion of the cable.

8-11. (canceled)

12. The method of claim 1, wherein the conformable material comprises a wire molded into the cable to confer conformability.

13-14. (canceled)

15. The method of claim 1, wherein the conformable material comprises a highly ductile metal molded into the cable to confer conformability.

16-17. (canceled)

18. The method of claim 1, wherein the conformable material comprises a highly ductile metal over-molded onto the cable to confer conformability.

19. The method of claim 18, wherein over-molding comprises a non-conductive material capturing the metal on the outer surface of the cable.

20. (canceled)

21. The method of claim 1, wherein the conformable material comprises a wire over-molded onto the cable to confer conformability.

22. The method of claim 21, wherein over-molding comprises a non-conductive material capturing the wire on the outer surface of the cable.

23-60. (canceled)

61. A method, comprising:
providing a consumer-salable kit, wherein the consumer-salable kit comprises:
a conformable material adapted to be attached to a separately sold cable; and
an instruction guide instructing a user how to attach the conformable material to the cable and how to position the cable once the conformable material has been attached.

62. The method of claim 61, wherein the cable comprises at least one of a power cord and a data cord.

63-64. (canceled)

65. The method of claim 61, wherein positioning the cable involves positioning and shaping the cable to at least one surface of an object.

66. The method of claim 61, wherein the entire length of cable is conformable.

67. The method of claim 61, wherein only a portion of the cable is conformable.

68-69. (canceled)

70. The method of claim 61, wherein the conformable material comprises a spiral stiffening member disposed along at least a portion of the cable.

71-73. (canceled)

74. The method of claim 61, wherein the conformable material comprises a highly ductile metal.

75. The method of claim 61, wherein the conformable material comprises a wire.

76. The method of claim 61, wherein the conformable material comprises a conformable sheath surrounding some or all of the conductors within the cable.
